(19) United States
(12) Patent Application Publication
(10) Pub. No.: US 2005/0215312 A1
(43) Pub. Date: Sep. 29, 2005

(54) Dice that recognize the values of their own throws and transmit them to computers, with applications to electronic and casino games

(76) Inventors: Yuval Arie Tresser, New York, NY (US); Ygael Aron Tresser, Brooklyn, NY (US)

Correspondence Address: INVENTION SOLUTION;C/O YUVAL TRESSER, Apt 1, 223 North 11th Street, BROOKLYN, NY, 11211, US

(21) Appl. No.: 10/810,529

(22) Filed: Mar. 29, 2004

(51) Int. Cl. G06F 17/00

(52) U.S. Cl. 463/22

(57) ABSTRACT

Dice are disclosed that detect their state, i.e., their own value once at rest, using for instance gravity, piezoelectricity, or photoelectric cells that are assigned to all faces to recognize the lower face. Said dice preferably transmit said state to a computer. Said computer may be the same that is used for the game that depends on the throw of the dice, or may be used mostly for display as for some casino games. Electricity is used in the die to let it determine its own state and transmit it. Economical protocols of transmission are used such as Bluetooth. Such dice may securely send alerts whenever deviations from a fair distribution of the outcomes is detected and can monitor small modifications of their balance to maintain their fairness. Part or all of the teaching can be realized as MEMS (micro electro-mechanical systems) or NEMS (nano electromechanical systems) modifications of usual dice.

### CROSS-REFERENCE TO RELATED APPLICATIONS

Not Applicable

### STATEMENT REGARDING FEDERALLY SPONSORED RESEARCH AND DEVELOPMENT

Not Applicable

### BACKGROUND OF THE INVENTION

One of the problems with electronic games is that they replace the real world by a simulated world, often considerably poorer in complexity. The problem of using chance components in a game is different since the random choice of cards out of a deck or the throw of dice can be more reliably fair in simulation than with the actual objects. What is often felt as cruelly missing from simulated throws of dice or from card distributions is the physical contact with the objects, be they cards or dice, and the combination of ambiance and ritual elements that accompany the use of the actual objects: for instance, some people like to blow on their hand holding the craps dice before they throw these dice in American style casinos while other people like to knock the dice on the side of the 421 game board in some French bars. It would thus be a great advantage to have the possibility to integrate the use of actual cards or dice into electronic games without the player having to tell, type, or otherwise input the outcome of the pull, distribution, or throw. We address here the case of dice.

### Background on Protocols for Wireless Local Area Networks

Ad-hoc transmission protocols can easily be developed and used for the purpose of the present invention as the amount of data to be transmitted by a dice to indicate the value on its top face is so small (3 bits, before treating the information for reliability). Using any standard protocol may force one to augment the volume of data to be transmitted. But, while in fact the choice of the protocol to be used (be it standard or ad hoc) is irrelevant to the invention, we believe that using a standard protocol (at least for consumer products) will greatly facilitate the adoption of the products developed on the basis of the present invention. More specifically, we think that using Bluetooth will make products developed according to the present invention more easily usable all around the world.

Due to the low energy levels available given the typical size of dice and obvious requirements such as not having to often replace batteries, economical protocols of transmission will preferably be used in the present invention, such as Bluetooth or versions of the IEEE (Institute of Electronic and Electrical Engineering) 802.11 standard. While versions of the 802.11 standard have been around for some time now, we recall some facts about Bluetooth to make the description of the invention more plain to more people who are interested in games and dice but may lack the rudiments of knowledge needed to understand why Bluetooth (or for that matter 802.11b for instance) can fulfill the role given to them in our invention. For general reference on Bluetooth, see for example. I: “Bluetooth Revealed: The Insider's Guide to an Open Specification for Global Wireless Communications,” by B. A. Miller and C. Bisdikian (Prentice Hall; 2000) and II: “Bluetooth Demystified,” by N. J. Muller (McGraw-Hill; 2000).

Thus, several technologies are now available to be used to operate WLANs (Wireless Local Area Networks) whish is what the wireless connection between dice and computers that we will describe is an example of. One of the preferred standards that we suggest to be used for the transmissions needed in implementing the present invention is the so called Bluetooth technology which is now popular in many applications (including some very familiar ones, such as communication between a keyboard or a mouse and a computer). The unit of intercommunicating devices in Bluetooth is called a Piconet. The Bluetooth wireless technology comprises specifications on hardware, software, and interoperability requirements. It provides for a low-cost, low-power, short-range radio link for mobile devices and for Local Area Network (LAN) access points that has been adopted by many of the players of the relevant industries (e.g., all major players in the telecom, computer and home entertainment industry and more). It offers reliable and mildly secure digital transmissions of data (and of voice, but that aspect will not be relevant to us) over the globally available, unlicensed, 2.4 GHz Industrial, Scientific and Medical (ISM) band. A key feature of the Bluetooth specification is that it aims at allowing devices constructed by lots of different manufacturers to work with one another. Bluetooth defines both a radio system and a software stack (the so-called Bluetooth Protocol Stack) to enable applications to find other Bluetooth devices in the area it is concerned with (e.g., its neighborhood within some radius), and discover what services they offer and use those services that they require. To make Bluetooth as robust as possible the operating band is divided into 1 MHz-spaced channels, each signaling data at 1 Mb/s (megabyte per second). The technology uses GFSK (Gaussian Frequency Shift Keying) modulation scheme and FHSS (Frequency Hopping Spread Spectrum) so that if a transmission is compromised by interference on one channel, the retransmission will always be on a different (hopefully interference free) channel. Each Bluetooth time slot lasts 625 μs (microseconds) and generally devices hop once per packet, giving a hop rate of 1600 hops/second. The agreement between the devices is done using one device as a Master and the others as Slaves: the whole group forms a Piconet.

We now give a list of properties of Bluetooth that we will use for easy reference in the course of describing the present invention in some preferred embodiments.
a) Every Bluetooth device has a unique Bluetooth Device address (BD address) and a 28-bit Bluetooth clock.
b) A Master can manage up to 7 devices (so up to 8 devices per Piconet).
c) The Slaves in the Piconet only have links to the Master: there are no direct links between Slaves.
d) The Slaves synchronize to the Master in time and frequency by following the Master's frequency hoping sequence.
e) In addition to controlling the frequency hop sequence at a hop rate of 1600 hops/second, the Master controls when Slaves are to transmit using Time Division Multiplexing (TDM).
f) Occasionally, two Piconets may collide on the same channel, but they will just hop off to new frequencies and retransmit any data that was lost.

### Background on Production and Storage of Energy

Again for accessibility to a wider audience, we collect here some basic facts about the energy resources relevant to the use of small devices. These facts will also help when it comes to some detection techniques as many effects enable both applications. The reader can also consult the many references we cite, and Wikipedia, a free encyclopedia on the Internet from which we quote freely.

I) Production

Mechanical energy has long been used to generate sustained regular movement as in watch mechanism. The art for that is quite old, and research still brings novelties as for instance in U.S. Pat. No. 4,363,553 to Thomi, et al. (Watch mechanism incorporating two barrels). We will call motion captor any system that thus transform motion into regular motion which can then, as we shall recall, be transformed into electricity. Non-rechargeable, rechargeable batteries, and/or capacitors will also be used in some embodiments of our invention.

I-A) Transducers A transducer is a device that converts one type of energy to another. For instance mechanical energy (as produced by a motor in a dynamo using discoveries by Faraday or by pressure, using the piezoelectric effect), thermal energy (using the Seebeck-Peltier effect), or photonic energy (using the photoelectric effect) will be converted to electricity. The electric energy produced by a transducer used in our invention will be used when produced and/or partly stored in a combination at least one of a capacitor and a rechargeable battery.

I-B-1) Mechanically generated electricity: Generators. An electrical generator is a device that produces electrical energy from a mechanical energy source. Electrostatic generators (e.g., Wimshurst machine, Van de Graaff generator) are inefficient. The dynamo is based on the discovery by Faraday in 1831-1832 that a potential difference is generated between the ends of an electrical conductor that moves perpendicular to a magnetic field. Pixii, von Siemens, Cooke and Wheatstone, Pacinotti, and Gramme developed the first forms of dynamos from 1832 to 1870. Thus a rotation sustained for some time allows the generation of electric energy that can then be used at production time and/or stored in at least one of a capacitor or rechargeable battery.

I-B-2) Mechanically Generated Electricity: Piezoelectricity. Piezoelectricity is the ability of certain crystals to produce a voltage when subjected to mechanical stress. In such a crystal the positive and negative electrical charges are separated but symmetrically distributed. When a stress is applied, this symmetry is destroyed, and the charge asymmetry generates a voltage. Piezoelectric materials also show the opposite effect, called converse piezoelectricity. The bending forces generated by converse piezoelectricity are extremely high. The displacement is of the order of a few nanometres. This can be used to build motors that move bodies around as needed, including at micrometric or nanometric scales.

In 1880, the brothers Pierre Curie and Jacques Curie predicted and demonstrated direct piezoelectricity in a variety of materials. Quartz and Rochelle salt (sodium potassium tartrate tetrahydrate) exhibited the most piezoelectricity. Twenty natural crystal classes exhibit direct piezoelectricity. Converse piezoelectricity was predicted by Lippmann in 1881, and was immediately confirmed by the Curies. In addition to the materials known since Curies, many other materials exhibit piezoelectricity. For instance the polymer polyvinlidene fluoride, (—CH2—CF2—)ₙ, exhibits piezoelectricity several times larger than quartz.
Converse piezoelectricity has been used to create devices like engines, in particular in the world of micro electro-mechanical systems and nano electro-mechanical systems (MEMS and NEMS).
Direct piezoelectricity of some substances like quartz can generate thousands of volts. It is widely used for instance in digital watches.
   I-C) Thermoelectricity

Seebeck effect: In 1823 the German physicist Seebeck discovered that a voltage was developed in a loop containing two dissimilar metals, provided the two junctions between the metals are maintained at different temperatures.

Peltier effect: A decade later, French scientist Peltier found that electrons moving through a solid can carry heat from one side of the material to the other side. Thermoelectricity, and the Seebeck-Peltier effect were born. They got to be explained later by Lenz.

The metals best suited for thermoelectric applications are uneconomical as a source of electrical power, but can be used for temperature sensing, as thermocouples. Some synthetic semiconductors can provide a useful amount of electrical power: thermal diodes, which are used for creating power from heat differentials.

A thermoelectric generator (or thermoelectric cell) is a heat engine that utilizes the electrons in the thermoelements as the working fluid rather than gas or vapor. A thermogenerator is a heat engine, which consists of so called p-type and n-type pieces of thermoelectric material (with “p” and “n” for positive and negative, notation and concepts about semiconductors that are well known in solid state physics and electronic engineering), which generates electrical current upon exposure to a temperature difference. The thermoelectrical properties of semi-conducting materials can change dramatically with temperature. Some, as Bismuth Telluride can be used for the purpose of the present invention, with an effective operating range of −100° C. to +200° C.: we need an effective operating range that contains usual room temperature and a bit more. Thermoelectric generators have no moving parts, and are small in size and light in weight. They have been widely used, in particular for electric power generation. Thermoelectric generators are environment friendly as they produce no pollutants and can use low temperature sources. For general reference, see for instance “Thermoelectricity” by P. H. Egli (Ed.) (John Wiley and Sons, New York; 1960) or the “CRC Handbook of Thermoelectrics” by D. M. Rowe (Ed.) (CRC Press; 1995).

I-D) Photoelectricity

The “photovoltaic effect” is the basic physical process through which some materials convert sunlight into electricity. It was first observed in 1839, by then nineteen-year-old Becquerel, a French physicist. Electrons are emitted from a surface (usually metallic) upon exposure to, and absorption of, electromagnetic radiation (such as visible light and ultraviolet radiation). The photoelectric effect is (for us) the related phenomenon (first recorded by Hertz in 1887 and explained by Einstein in his 1921 Nobel Prize winning paper “On a Heuristic Viewpoint Concerning the Production and Transformation of Light” published in 1905) whereby no electrons are emitted for radiation below some threshold frequency particular to each type of surface. As far as energy production or radiation detection is concerned, we will say indifferently photovoltaic cell or photoelectric cell. Solar cells usually refer to assemblies of photoelectric cells, but the name is simpler and makes for better marketing, so that solar cell is also sometimes used to mean photoelectric cell.

In 1901 N. Tesla received the patent U.S. Pat. No. 685,957 (Apparatus for the Utilization of Radiant Energy) that describes radiation charging and discharging conductors (ex., a metal plate) by “radiant energy”. Tesla used this effect to charge a capacitor with energy by mean of a conductive plate. These devices (indeed solar cell precursors) have been referred to as “Photoelectric alternating current stepping motors”.

A photodiode is a p-n junction designed to be responsive to optical input. Photodiodes are provided with either a window or optical fiber connection, in order to let in the light to the sensitive part of the device.

Photodiodes can be used in either zero bias or reverse bias. In zero bias, light falling on the diode causes a voltage to develop across the device by the photovoltaic effect. In reverse bias, diodes usually have extremely high resistance. This resistance is reduced when light of an appropriate frequency shines on the junction. Hence, a reverse bias diode can be used as a detector by monitoring the current running through it. Circuits based on this effect are more sensitive to light than ones based on the photovoltaic effect. A phototransistor works like a photodiode, but with a much higher sensitivity for light.

Thus, beside its use in energy production, the photoelectric effect is also used for light detection. Different materials are usually used for these different purposes if high efficiency is required. Without the worry for efficiency, one may use the same cell for both energy production and light detection.

For references to the utilization of the photoelectric effect in the context of watches that are, like dice, also small devices, see for instance U.S. Pat. No. 4,785,436 to Sase (Photovoltaic electronic timepiece), U.S. Pat. No. 6,181,648 to Mafune, et al. (Electronic watch equipped with solar cell), and U.S. Pat. No. 6,144,621 to Sase (Charging type electronic timepiece).

II) Storage

II-A) Usual Non-Rechargeable Batteries

We will not recall anything on non-rechargeable batteries whose usage is plain when we need them, but only recall a few things on re-chargeable devices as they interact in a complicated way with the rest of the equipment. The “Handbook Of Batteries” by D. Linden and T. B. Reddy (Eds.) (McGraw-Hill Professional; 2001) is a general reference for anything related to batteries.

II-B) Capacitors

Traditional electrostatic capacitors have the highest peak specific power (up to 10⁴ kW/kg) of prior technologies for electricity storage. Miniature capacitors have unacceptable useful discharge times (and hence unacceptable energy storage capacity) for most applications but could be used for the very special usage of the present invention. The exponential decay in power output vs. time is not suitable for most applications that require a flatter discharge profile: but our data transfers are tiny. The advantage of electrostatic capacitors is that high voltages are possible, limited only by the ability of the dielectric material to sustain the voltage.

II-C) Rechargeable Batteries

In contrast to capacitors, traditional secondary (rechargeable) batteries, which store energy in chemical form, have normally been designed to maximize the specific energy, at the expense of the specific power.

II-C-1) Usual Rechargeable Batteries

Lead-acid batteries are the most commonly used rechargeable batteries today but have one of the worst energy per weight ratios. Caution must also be observed because of the extremely corrosive nature of sulfuric acid.

Nickel-cadmium batteries (or NiCd or NiCad) are a type of rechargeable battery first developed in 1961. They are commonly used in many portable electronic devices. NiCd batteries contain cadmium, which is a toxic heavy metal and therefore requires special care when the batteries are disposed of.

A Nickel metal hydride (or NiMH) batteries are similar to NiCd, but less toxic.

Lithium ion batteries (or Li-ion) have become very common and dropped in price recently. They provide one of the best energy-per-weight ratios of rechargeable batteries at present. They have succeeded NiMH and NiCd batteries in consumer electronics such as cellular phones and notebook computers. Li-Ion batteries need at least 4 hours to fully charge. Li-ion batteries are not as durable as NiMH and NiCd designs, although they do not suffer from the memory effect. One great advantage of Li ion batteries is their low self-discharge rate of only approximately 5% per month, compared with over 30% per month and 20% per month in NiMH batteries and NiCd batteries respectively. The life cycle of a Li-Ion battery is dependent upon aging from time of manufacturing (shelf life) regardless of its use.

Lithium polymer batteries are rechargeable batteries that have technologically evolved from lithium ion batteries. The lithium salt electrolyte is not held in an organic solvent, like in the proven lithium ion design, but in a solid polymer composite such as polyacrylonitrile.

These batteries are less hazardous if mistreated. Furthermore, since no metal battery cell casing is needed, the battery can be lighter and it can be specifically shaped to fit the device it will power. Because of the denser packaging without the holes between cylindrical cells and the lack of metal casing, the energy density of Li polymer batteries is over 20% higher than that of a classical Li ion battery.

The Lithium Polymer still has some serious problems with internal resistance and has a limited life cycle. Further disadvantages include long charge times, (an hour or more compared to NiCd 15 minutes) and the slower maximum discharge rates.

The main advantage to it compared to a standard Li-Ion is that manufacturers can change the shape of it which can be critically important to mobile phone manufacturers who are constantly working on small, thinner and lighter phones.

The “Handbook Of Batteries” by D. Linden and T. B. Reddy (Eds.) (McGraw-Hill Professional; 2001) is a general reference on batteries that also covers rechargeable batteries.

II-C-2) Novelties in the World of Rechargeable Batteries

The major obstacle in using batteries in MEMS is the size and weight of available batteries, but small enough batteries are now being proposed, so that the energy needs for our inventions will have several solutions, and more as other needs for small energy supplies drive the improved availability of small energy sources.

A thin-film battery in described in U.S. Pat. No. 5,455,126 to Bates, et al. (Electra-optical device including a nitrogen containing electrolyte), and a MEMS battery is described in U.S. Pat. No. 6,610,440 to LaFollette, et al. (Microscopic batteries for MEMS systems).

### Prior Art and Ideas Related to the Invention

It has recently been proposed to have dice being rolled on special decks, made for instance of photo-sensitive elements that would allow to read the bottom face of the dice once they have stopped, or have transponders near each faces of the dice and have the computer detect which faces of the dice are against the board and deduce the ones on top (see http://www.halfbakery.com/idea/Computer 20Input 20Dice). One can also use cameras to capture the top faces of the dice after the throw. Clearly, technologies are now available (both from the point of view of the hardware and of the software that are needed to perform the required pattern recognition) which would allow anyone skilled in modern technologies to realize some of these approaches. Except that in the document cited above, no means were disclosed as to how the computer would detect the transponder lying face down on the board. Thus these solutions, or at least those which are described with enough precision to be implemented by someone skilled in the art, create requirements and environments that are not the usual ones when throwing dice, and the camera approach is marred by the fact that at least some hands may come in the way if no proper care is taken. Also in some games such as craps, dice can be required to go into very large available spaces, so that the transponder idea is not trivially turned into a workable solution. Furthermore, the problems of timing the input mechanism without extra human supervision need to be addressed to transform good solutions into much better ones: if the goal is to avoid inputting the result of a throw of a die by voice or other means, it would be much better to avoid any human action telling the computer when to fetch inputs from the dice, and when to stop doing so.

It would thus be advantageous to have cheap small special boards and even better, dice that can be rolled essentially anywhere, with no need of a special board. Cheap special boards will not be described here except as some variations of special preferred embodiments of our invention: the present invention discloses dice that compute the values of their own throws and transmit them to some entity such as a computer using Bluetooth or some other wireless protocol such as a 802.11b for instance.

### BRIEF SUMMARY OF THE INVENTION

Dice are disclosed that detect their state, i.e., their own value once at rest, using for instance gravity, or piezoelectricity, or photoelectric cells that are assigned to all faces to recognize the lower face. These dice preferably transmit said state to a computer. Said computer may be the same computer that is used for the game that depends on the throw of the dice, or may be used for display in case the real game is not in the computer world, but computers are mostly used to enrich the experience, as for some casino games. Electricity is used in the die to let it determine its own state after a throw and transmit it to the computer. Batteries or production systems, which use mechanical, thermal, or photonic energy to produce electricity, that is stored for immediate or for later use in a capacitor or a rechargeable battery, can be used each by themselves or in combination. Mechanisms that draw energy from motion or from heat can be used as a sole source of electricity, or only to control the opening of communication channels with the computer after the dice are thrown. Economical protocols of transmission are used such as Bluetooth or versions of the 802.11 protocols, or ad-hoc protocols. These protocols allow a single receptor to distinguish between receptions from several dice. Furthermore, the range of communication can be adjusted to allow for several games to be played in the same room. Light versions of secure computing are used to treat the signal before transmission so that it is protected against accidents and naïve attacks. For some professional applications, for instance if high security is required that involves using physical protection against aggression, such dice are also able to securely send alerts whenever abnormal deviations from a fair distribution of the outcomes of all faces is detected. Optionally, the embedded operating system can monitor small modifications of the balance of a die to maintain its fairness. Part or all of the teaching can be realized as MEMS (micro electro-mechanical systems) or NEMS (nano electro-mechanical systems) size modifications of usual dice.

### BRIEF DESCRIPTION OF THE FIGURES

The principles and main advantages of the present invention will be better understood on examples illustrated by the figures to follow, where:

FIG. 1 represents means to provide energy to the systems that will be embedded in dice according to the present invention.

FIG. 2 represents alternate ways to distribute in a die the weight associated to energy sources.

FIG. 3 represents a first mean for a die to determine which face is the bottom face, hence which face is the top face.

FIG. 4 represents a second mean for a die to determine which face is the bottom face, hence which face is the top face.

FIG. 5 represents a third mean for a die to determine which face is the bottom face, hence which face is the top face.

FIG. 6 represents some of the ways the conducting components that are used in the methods illustrated in FIGS. 4 and 5 can be related to the poles of electricity generating systems such as batteries, taken here as examples of sources of energy with two polarities, with no intent of limitation on the electricity generators that could be used.

FIG. 7 represents a fourth mean for a die to determine which face is the bottom face, hence which face is the top face.

FIG. 8 represents a die equipped with more embedded computing power, and a secure barrier to protect against fraudulent attempts to reach the computing equipment of the die.

FIG. 9 represents a die with means to correct small departures from fairness if any.

### DETAILED DESCRIPTION OF THE INVENTION

We shall call state of the die the value of the top face of the die at rest, or the more precise result of which of the faces of the die is its bottom face at rest. The bottom face of the die will be deductible or will be deduced from the state in which some embedded system (using gravity or some physical effect) will find itself after the die has reached some rest position, and lies on a face which is then the down face. The fact that the knowledge of the value on the face that is up is deductible from the knowledge of which face is down is a plain result of the Standing Assumption that we make that:
“Any dice involved is known and in particular, one knows which face is up when one knows which face is down.”

This does not imply for all dices that one can deduce the value of the top face from the value of the bottom face since dice can be conceived with many intent and forms, and in particular with many of their faces carrying the same value if so designed. Otherwise speaking, the Standing assumption takes into account the fact that the knowledge of a face is in full generality more precise than the knowledge of the value on that face. We notice that the value of the top face of the die is what is needed, and not the identity of the top face itself in case there are several faces with carry the same value (except possibly to study the statistics of the throws and check the fairness of the die); the status of the bottom face is different because one must deduce from its knowledge the value that can be read on the face opposite to it. The correlation between the value of the top face and the identity of the bottom face of a die is trivial once one knows which type of die (e.g., regular numbered die, poker die, Yangtze die, or special purpose die) is used since by the Standard Assumption, the description of a die covers the description of what are its pairs of opposite faces. This is quite important as the system we propose will involve transmission of some identifier of the dice, which in particular would tell which kind of dice is involved, under the Standing Assumption.

We thus propose here dice that can detect their own state by using for instance:
A) Gravity,
B) Or gravity as generating piezoelectricity to recognize the lower face,
C) Or photoelectric cells that will be assigned in different number and/or with different performances to all faces so that the face in contact with the table is the only one whose cells do not generate electricity, or do not allow to emit signals whose strength is above some predetermined threshold.

We notice that solution C adapts trivially to one with a special board that emit some field (electromagnetic field, i.e., photons) that is caught better by the photoelectric captors near the face at the bottom. In fact beside or instead of light or other electromagnetic radiation, the board could emit heat but the cells would then be thermoelectric, using the Seebeck effect. Special boards as these are quite simple and could allow the dice according to this invention to be less precise than dice that could be used with no special board at all.

The state of the die after a throw, and detected by the die itself using some mean to do that such as one of the means A), B), or C) listed above or some combination thereof for instance, is transmitted to one or more computers. This transmission (according to the Standing Assumption) will always preferably contain a description of the die that allows in particular to know what is the value of the top face once the bottom face has been identified, and a serial number (as provided for instance by the BD Address: see property a) of Bluetooth above) of the die that allows to have a complete description of the throw when several dice are involved in the throw. This would avoid confusion if several sets of dice are being used for several games in the same room and close to each other. This description of the die can be omitted if the BD Address or other serial number is accompanied by a description of the die in a (local or remote) storage place available to the computer, or if the game that is played only uses one kind of dice and the description of the die being used is known by default. One may also prefer the top value to be computed in the die and be then the information being transmitted to computers.

Said computers may be where the games that depend on the throw of the dice are plaid. Alternatively, the computers can be used for display purposes only in the case when the game associated to the throw of the dice is not happening in the computer world. In that instance, computers could be used to enrich the experience, for instance by monitoring displays that tell the output of throws and can for instance be seen by a large crowd, for instance in casinos.

Electricity will be used in the dice sometimes to let the dice determine their own state after a throw, and in any case to let the dice transmit their states. Use of resonating tags that are not conceived to use electricity inside the die but need special equipment in the direct or close vicinity of where the die is thrown, would defeat the purpose of this invention which is to avoid the need of heavy equipment, or better of any equipment, that would need to be used in conjunction with the dice and the usual computer environment (we do not mention a communication system to communicate with the dice, as such communication systems are more and more standard on computers anyway). In fact, involving other elements to read, assess, or generate the electricity needed to determine the state the die is what this invention is purposely avoiding. Mechanisms such as the ones used in watches that draw energy from motion can be used as a sole source (or as one of the sources) of electricity. These mechanisms could be used otherwise for a specific purpose, for instance to control the opening and closing of communication channels with the computer after the dice are thrown. Batteries can also be used just by themselves or in combination with other energy generators. For instance:
Piezoelectricity activated by the pressure of the die on its bottom face and stored in a battery or capacitor,
Motion-powered batteries or capacitors where energy is drawn from the roll of the die until it stops and is transformed into sustained rotation in a machine like a watch mechanism, to be transformed into electricity using a dynamo,
Heat-powered batteries or capacitors (thermoelectric cells) that use the heat of the hand that throws the die,
And light-powered batteries or capacitors (photoelectric cells) where energy is drawn from the ambient light
   are other possible sources of energy for state detection, state transmission, or for both of these purposes.

Due to the low energy levels available given the typical size of dice and to the obvious requirement not to have to often replace batteries, economical protocols of transmission will be used such as Bluetooth or versions of the IEEE (Institute of Electronic and Electrical Engineering) 802.11 standard. Such protocols are well suited to support substantial levels of security, enough for instance to prevent accidental mistakes in the states transmissions. In particular, these protocols allow a single receptor to simultaneously accommodate and at the same time to distinguish receptions from several sources, so that games that use several dice can be accommodated (see Property b) of Bluetooth above). From property c) of Bluetooth above, the computer, rather than one of the dice will be chosen as Master, and the same will apply to any technology with similar Master-Slave dichotomy. Given the short characteristic times associated to Bluetooth and the smallness of the data sets that need be transmitted by each die (just its state, if any), and since the Master can use the BD Address identifiers of the dice being used and invoke them all each in their own times, the system will easily allow a single computer to handle as many dice as needed beyond the limit of 7 at a time that was described earlier. Anyway, most games use less than 7 dice at a time, and it is plain that several receptors could be used as well to handle more that 7 dice at a time (see Properties d) to g) of Bluetooth above). Furthermore, the range of transmission and reception can be adjusted if one desires several independent games to be played in the same room. In the case of Bluetooth, there could be several independent Piconets in the same room, something the technology can easily achieve. The Bluetooth Technology also allows the computer to deal in the most straightforward way with several dice in the same Piconet as a Bluetooth mouse and a Bluetooth keyboard (see property b)) and to deal with more complex situations using the so called Scaternet configuration (see the general references to Bluetooth I and II). Another option for handling several dice at a time as we have discussed above, would be to use the small amount of data that the die has to transmit and involve the BD Addresses.

Light versions of very secure computing (such as can be supported for instance by light version of the Linux Operating System (OS)) will be used to treat the signal before transmission if needed for some professional applications and whenever very high levels of security will be required. We will be using the same physical protection techniques against aggression applied in building secure (tamper evident and keys erasing) computing environment such as secure hardware involving the use of secure cryptographic coprocessors. In combination with these protection techniques, the dice will be able to securely take account of the succession of their throws, and:
Send an alert when abnormal deviations from a fair distribution of the outcomes of all faces will be detected,
Or assess such deviation of the fairness of the die upon authorized request for information by who has access to the key to ask such questions.
   Optionally, the embedded Linux machine (or alternate OS) will securely monitor small modifications to the balance of the die, which will enable re-establishing the fairness of the die.

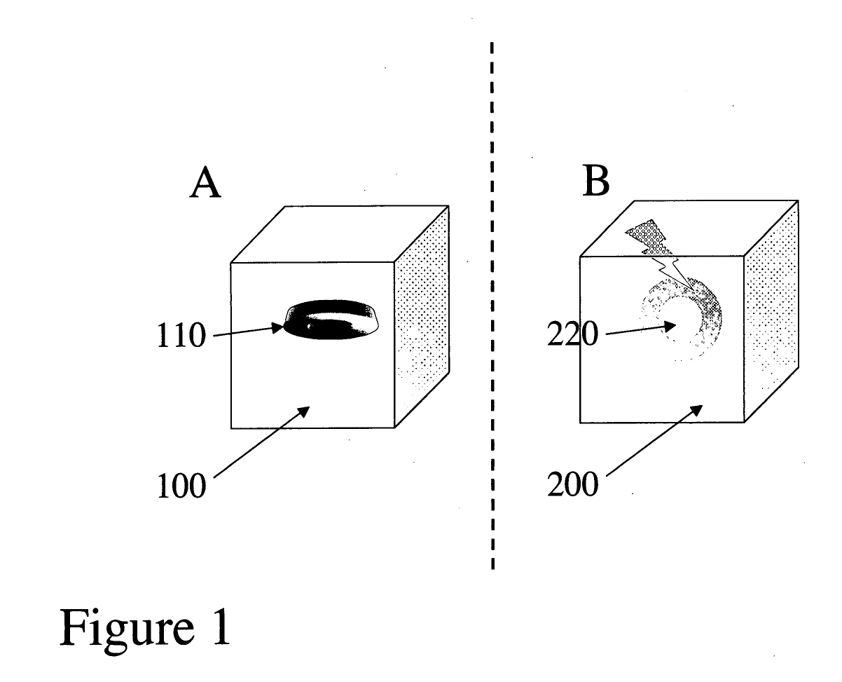

With reference now to FIG. 1, we see at 100 a die according to the present invention, equipped with a battery at 110, and at 200 a die according to the present invention, equipped with a motion captor energy source at 210. To avoid duplication of figures and of text, each time we write battery, it can mean a regular (non rechargeable) battery (for instance without any purpose of limitation, a lithium or a silver cell) or a rechargeable battery (like a lithium polymer battery or a battery as described in U.S. Pat. No. 5,455,126 to Bates, et al. or in U.S. Pat. No. 6,610,440 to LaFollette, et al., for instance) or a capacitor that gets all or par of its energy from one at least of:
A) Mechanical energy where:
   A-1) Either a mechanism like in classical watches (see, e.g., U.S. Pat. No. 4,363,553 to Thomi, et al. (Watch mechanism incorporating two barrels) for recent new technologies of this type): the motion of the watch mechanism is then transformed into electricity by a dynamo,
   A-2) Or piezoelectricity is used (as also often used in some watches), where the weight of the dice for instance, is used to produce electricity from pressure exerted on an element of a piezoelectric substance such as quartz or Rochelle salt or the polymer polyvinlidene for instance,
B) Heat (thermoelectric cells), a technique using the thermoelectric effect or the Seebeck part of the Seebeck-Peltier effect (see for instance “Thermoelectricity” by P. H. Egli (Ed.) (John Wiley and Sons, New York; 1960), or the “CRC Handbook of Thermoelectrics” by D. M. Rowe, (CRC Press: Boca Raton, Fla.; 1995): the heat of the hand that throws te die is then the primary source of energy.
C) Light or other electromagnetic radiations in another wavelength band (photoelectric cells), a technique using the photovoltaic or photoelectric effect, and which has known great success in watches (see for instance U.S. Pat. No. 4,785,436 to Sase (Photovoltaic electronic timepiece), U.S. Pat. No. 6,181,648 to Mafune, et al. (Electronic watch equipped with solar cell) (solar cells we recall, are often assemblies of photoelectric cells, but sometime, even if photoelectric would be better, the words “solar cell” are used because of marketing reasons for instance), and U.S. Pat. No. 6,144,621 to Sase (Charging type electronic timepiece)) as it avoids all need for battery changes: ambient light (or other radiations in another wavelength band) is then the primary source of energy.

We have already mentioned that solutions B and C above are appropriate for a mixed solution where heat for solution B, and light for solution C, is emitted by a special board. Said emitted thermal or electromagnetic field which has been introduced here as energy source, can also be detected better by the bottom face of the dice to allow the die to determine its state before the energy is used to transmit it.

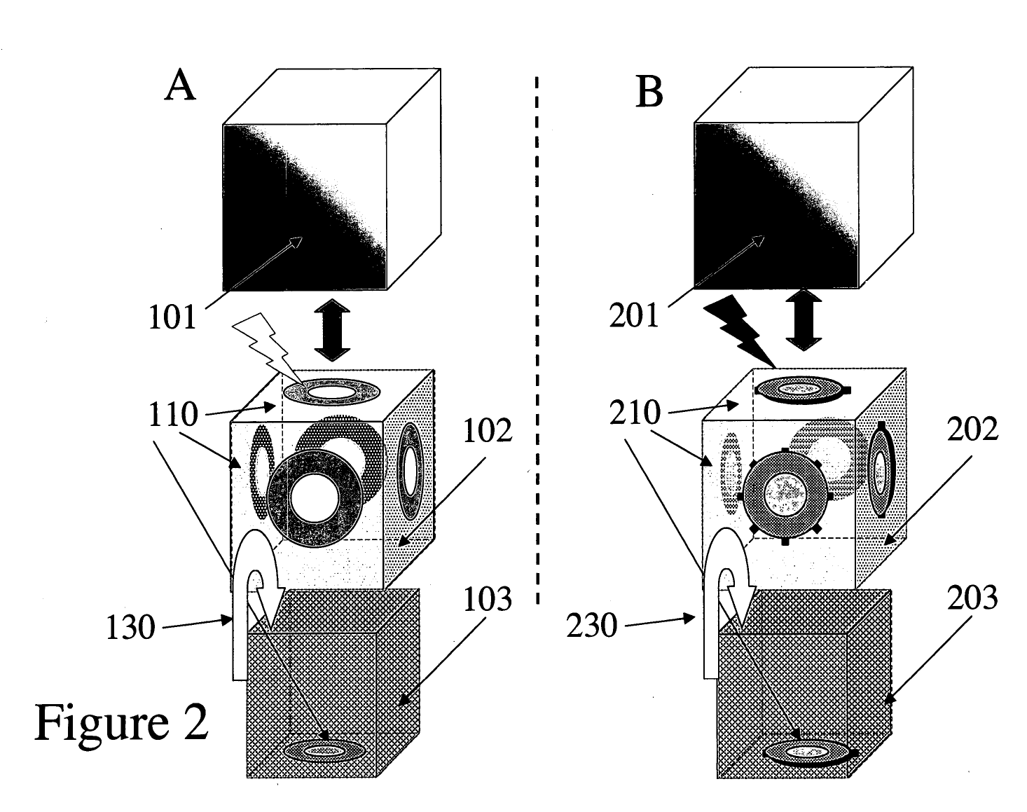

While sources of energy such as batteries or motion captors (and there might be several sources of energy in the same die) can be put towards the center of the die, it may be preferable to put one or several copies of either of the energy solutions as indicated in FIG. 2. As illustrated there, six batteries or motion captors are inserted (one near each face), either in a replaceable way, by using for instance the geometry of embedded boxes that is shown in FIG. 2. Or the energy source could be installed permanently, specially for the motion captors or the photoelectric cell batteries that would seldom require any replacement. Instead of installing six batteries or motion captors, one can use objects with the same weight and mass distribution to keep a better balance of the die without hard to achieve re-balancing needed. Notice that since motion captors typically have moving parts, replacing them with equivalent counter-weights would not be easily possible without having moving parts in those counter-weights as well. Thus, high quality dice using motion or light captors as source of energy would preferably use a single captor with the same symmetries as the die and place it in the center, otherwise one would need to use six captors and place each one close to each of the six faces of the die.

On FIG. 2, in part A, we have a 100 type die (one which has some energy from a battery). The die is composed of three layers named 101, 102, and 103. The outer layer 101 is an open box with five faces. Layer 102 is the middle layer and is also an open box. The layer 102 is oriented as the layer 101, so that in particular the open face of 102 is oriented in the same direction as the open face of the 101 layer. Thus when the 102 layer is inserted into the 101 layer none of the faces of 102 are exposed faces of the die. Layer 103 is the inner layer of the structure. It is also an open box with its missing face oriented in the direction opposite to that of the bigger 101 and 102 outer layers. Thus, when this last layer is inserted into the structure, the face that is opposite to the missing faces of 101 and 102 will close the die and will serve as its missing face. The curved arrow named 130 indicates that the sixth battery (or possibly bogus battery used as counterweight for some of them) comes inside 103.

In parallel, still on FIG. 2, but now in part B, we have a 200 type die (one which has some energy from a motion captor and/or from a captor of some other energy like piezoelectric, thermal, or photonic). The die is composed of three layers named 201, 202, and 203. The outer layer 201 is an open box with five faces. 202 is the middle layer and is also an open box. The open face is oriented in the same direction as the 201 layer. Thus when the 202 layer is inserted into the 201 layer none of the faces of 202 are exposed faces of the die. Layer 203 is the inner layer of the structure. It is also an open box with its missing face oriented in the direction opposite to that of the bigger 201 and 202 outer layers. Thus, when this last layer is inserted into the structure, the face that is opposite to the missing faces of 201 and 202 will close the die and will serve as its missing face. The curved arrow 230 indicates that the sixth motion captor (and/or captor of other form of energy such as piezoelectricity, heat, or light or possibly bogus captors used as counterweight) comes inside 203. As mentioned previously, motion captors or captors of other sorts of energy would not need replacement so that the structure in column B of FIG. 2 is more about the way to build the die rather than about the way to open it. In fact, given the very low consumption of energy entailed by Bluetooth technology, even a non-rechargeable albeit good quality battery would seldom need replacement, especially if motion (and/or other energy) detectors are used in conjunction, as we will describe, to create time windows during which the battery will be used. Since joint use of batteries and motion captors (and/or captors of some other sort of energy) is one of our preferred embodiments, in the sequel, we will use 300 to designate a die that either use both forms of energy sources or one of them which remains unspecified: as we shall see, none of the cases preclude having yet further sources of energy. We will use the number 200 to designate a die that we mean to have a motion (and/or other energy) captor, even if it may also have a battery or a capacitor (a battery or a capacitor we recall, may get part or all of their energy from a variety of primary energy sources through appropriate transducers).

Also present in the die beside the energy storage and possibly transducers (energy captors) are at least one processing unit and at least one communication system and means for the die to detect its state. All these systems must be taken into account when balancing the die, and non-homogeneities of the substance used for filling the remaining space can be used. For instance one can manage that all active parts in state determination and transmission thereof come respecting the cubic symmetry of the die as we discussed for the batteries, or are placed in such a way that nothing occupies the images of their place under the symmetries that let a perfect cube invariant. Then using heavy and light powders to modify the density of some plastic material that would be used to fill the die (such as ebonite or preferably some more modern plastic material), one would balance the active elements by properly placing the powders to recover the symmetry of the dice.

However, we notice that all these systems can be made quite small: since the state of the die, once the die is known, is contained in three bits (as there are six faces, but other, exotic dices could also be built using with minor changes the teaching of the present invention), the size of the processing apparatus can theoretically be quite small, of the order of a few molecules. Furthermore, the recent developments in micro and nano technologies, and in particular in micro electromechanical systems (MEMS) and nano electro-mechanical systems (NEMS) (as covered for instance in “The MEMS Handbook” by M. Gad-El-Hak, Editor (CRC Press; 2001), “Nano- and Micro-Electromechanical Systems: Fundamentals of Nano- and Microengineering” by S. E. Lyshevski (CRC Press; 2000), “MEMS and NEMS: Systems, Devices, and Structures” by S. E. Lyshevski (CRC Press; 2002), and “Modeling MEMS and NEMS” by J. A. Pelesko and D. H. Bernstein (CRC Press; 2002)), and that include:
1) the sort of sensors that we need (see, e.g.,
   a. a pressure sensor in U.S. Pat. No. 6,199,575 to Widner (Miniature combination valve and pressure transducer system),
   b. a piezo-resistive pressure sensor U.S. Pat. No. 6,306,773 Adas, et al. (Method of producing a semiconductor device of SiC),
   c. and a movement sensors in U.S. Pat. No. 6,701,788 to Babala (Multiple output inertial sensing device)
2) MEMS transmission system as we need (see, e.g.,
   a. “RF MEMS: Theory, Design, and Technology” by G. M. Rebeiz (John Wiley & Sons; 2002)
   b. and “RF MEMS Circuit Design for Wireless Communications” by H. J. De Los Santos, (Artech House; 2002)
3) MEMS size batteries (see, e.g., U.S. Pat. No. 6,610,440 to LaFollette, et al. (Microscopic batteries for MEMS systems) and references therein.

All these allow one to build dice according to the teachings of present invention, where either all or part of the equipments following these teachings at the microscopic or nanometric scale, so that issues related with balance would be irrelevant or mostly irrelevant. Even more, with these microscopic or nanometric scale technologies that are now more and more accessible and cheap, one could get for little extra cost dice according to the present invention that have the look and feel of traditional dice.

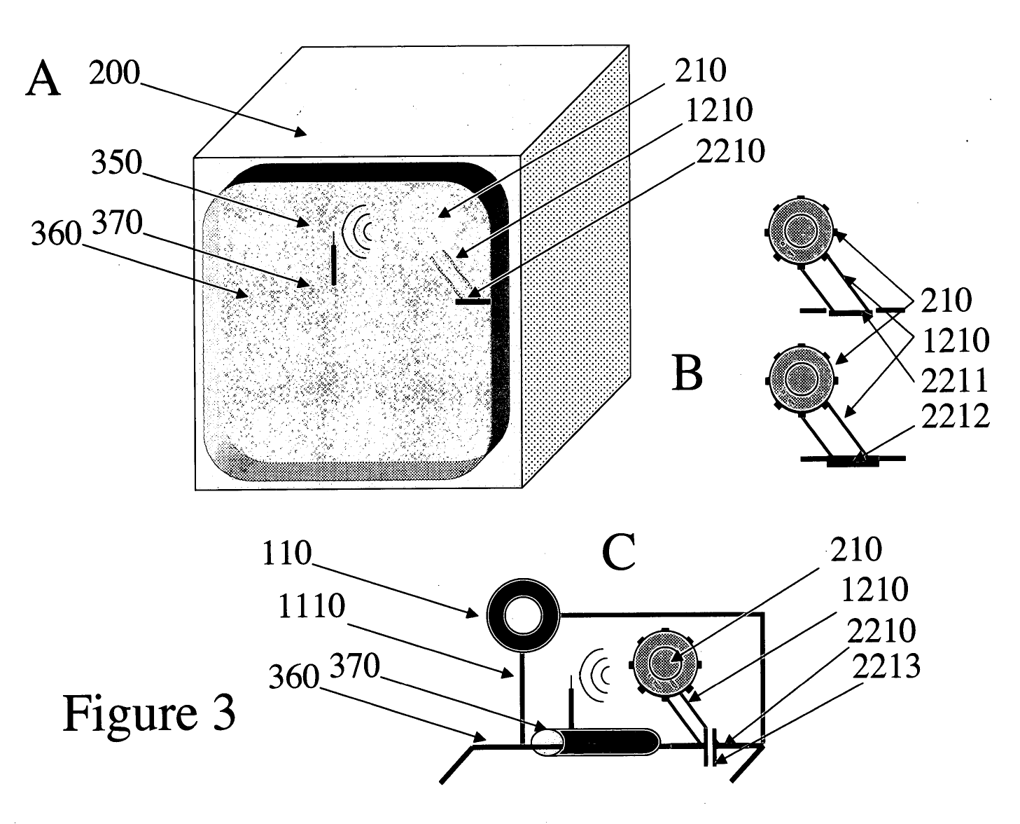

FIGS. 3, 4, 5, and 7 relate to mechanisms for “a die to itself have mean to recognize its top face or equivalently its bottom face”. By this statement, we mean that the signal transmitted by the die contains all information needed to recognize which face is up, except possibly the identity of the die, such as provided by a serial number (or BD address: with Bluetooth, the BD address would be transmitted and would generally suffice, so that serial number will mean “serial number or BD address is sufficient”). This information may be input once and for all when the system is installed in the computer: but we suggest transmission each time of the serial number and of the description of which pairs of faces are opposite to each other or the accessibility for the computer to this information, stored remotely or locally in a memory that would be read whenever needed. This exchange of information is done without need to recourse to signals provided by further apparatus such as a board on which the dice are rolled or a camera that would capture images of the dice. Notice that the die recognizing its top face (we also say that “the die knows its state”) in the sense that we have defined does not prevent using other means to observe the die. We will also say that “the die knows that it is in a final state” (or that “it knows when it is stabilized”) when it transmits information after a throw that is sufficient for the computer to recognize that the die is stable (that it has stopped rolling) and that the value of the top face has been determined. For instance, if the die emits information on its state only during a short time covering the time when it has stabilized, the stable state will be transmitted many times in a row and the computer program will then decide that this repeated information, that is followed by a time when no information is emitted, is the stable information to be used to describe the outcome of the throw. The systems presented here will easily allow to incorporate information treatment instructions that will declare that a throw is invalid and needs to be repeated if the rule of the game being played contains provisions for such non-decidable outputs.

With reference now to FIG. 3, we see in part A of FIG. 3 a die 200 according to one preferred embodiment of the present invention. We have indicated at 350 a piezoelectric element (e.g., a quartz) that will be placed so that it supports the die when the corresponding face is down. Recall that piezoelectric materials are substances that produce electricity when pressure is exerted upon them and that the fact that there is such a production of electricity is called the piezoelectric effect. Clearly, it is intended that all faces would be similarly equipped if such quartz (or more generally piezoelectric) plates are chosen as the mean, or as one of the means, for the die to recognize which face is up (indirectly by first detecting which face is down) The current produced by the piezoelectric element activates a Bluetooth broadcast station at 370 that will communicate the identity of the face under pressure, from which the identity of the top face of the die (from which the value of that face can be determined) is easily computed or looked up.

Optionally, to avoid permanent emission from the broadcast station associated to the face supporting the weight of the die (if any), a circuit breaker 2210 can be prompted by circuit 1210 activated by the motion detector 210 that will generate electricity for a short period when, and only when, the die has been in violent motion as for a throw of the die. Such motion related circuit enablement has the virtues of sparing energy consumption and of helping recognize when data about he die should be seized and used by the computer. Since the motion captor can enable the circuit before the die has stopped, the computer will register possibly a non-constant face, and will recognize the end state of the die as the value that is constantly emitted after possibly some preliminary stage when the face transmitted changes as the die rolls. Such consideration may help making decision when a throw has an acceptable output, which could be defined as when a face ends up supporting enough of the weight of the die to transmit the associated state.

Using the motion sensor as the provider of the energy that is used for transmission is possible but would prevent later re-asking for the results by the computer in case transmission failed, something that can be taken care of in the solutions we have detailed. As usual, tradeoffs, and in particular tradeoffs with cost, may encourage one to use non-optimal solutions.

We will see later how the use of a processor in the die in conjunction with the sensors leads to other means to limit the time of transmission, and advantages associated to such solutions.

Since the circuit breaking associated to motion is important, we detail it part B and C of FIG. 3. Thus, with reference still to FIG. 3, but now to part B, we see that circuit 2210 that was figured in part A can come in two shapes, 2211 and 2212 according to whether or not it is heated by an electrical current generated by motion captor 210. When it is no heated, the circuit 360 is broken so that the piezoelectricity generated at 350 cannot send any signal. However, after motion such as generated by the shaking, throwing, and rolling of the die, the current generated by 210 generates situation 2212 by heating circuit element 2210, which closes the circuit 360. Instead of motion, one can use the heat of the hand that holds the dice before they are thrown to generate the current that closes circuit 360. This comes in context with what we have already discussed when presenting choices available as energy sources. Here we speak of energy together with the timing of that energy production so that either the roll of the die, or the die being held in a hand before the throw, are appropriate sources of energy to close the aforementioned circuit. Of course, all similar circuits, one for each of the six faces, will be closed by the throw or the holding of the hand, but after the die comes to rest, only one piezoelectric face will be in contact with a surface to generate a sustained message that the corresponding face is down. This will easily allow the computer to reconstitute the rest state and thus get the information of which face is up. The cooling down, and more importantly the contraction of circuit element 2210 to a position where the circuit 360 is open should be slow enough for the die to come and stay at rest in the range of one tenth of a second to one second. During that time interval several messages should be sent by the emitter 370 to tell that the face it is associated with is the bottom face of the die.

The algorithms used to extract the up face from the down face are trivially implemented by anyone skilled in the art. Knowing the die game being played: regular dice (where the sum of opposite sides is equal to seven) are different from, say, Yangtze dice, but it can easily be adapted to any die specified by values of the faces and relative positions of the faces associated to each of the values (in particular, one can accommodate usual dice that carry different values or symbols on each faces, or special dice such that more than one face carry some of the values or symbols). As we mentioned before, the transmission by the dice of its state may comprise a full description of which pairs of faces are opposite to each other which makes the deduction of the top face out of the knowledge of the bottom face even more trivial.

Turning next to part C of FIG. 3, we see a capacitor element 2213 which can be used to close circuit 360 when enacted by motion captor 210. This approach is different from the one in part B where circuit element 2210 has a contracted, circuit breaking position and a dilated, circuit closing position in that 2210 can only be traversed by the current generated by motion captor 210 until it is dilated and further current can come through, and the current when discounting the motion captor is not enough to keep element 2210 dilated enough. In part C the capacitor-carrying portion of the circuit is potentially actionable by the piezoelectric element, and even possibly by some battery. However, the current generated without the extra contribution of the motion captor is not sufficient to generate a signal through the gap of the capacitor 2213. This use of the motion captor, making its contribution needed for some circuit to close, is one way to get dice according to the general principles of the present invention: once required during the course of the game, the dice gets activated by the throw. The states of the dice after a throw are recognized and input in the play of the game without any player having any further input to make such as indicating that the throw has been performed and/or that the information sent by the dice about their state is complete so that the game can proceed and/or what is the outcome of a throw.

In that respect, one may decide that a state of a die is decided if and only if that die transmits a clear message of what it judges that its state is (possibly in conjunction with the computer with which it communicates), and avoid all human calls or describe very carefully the few exceptions when humans can decide that a throw did not stop in a way that yields an acceptable state of the dice.

The solution in part B may also accommodate a battery, and likewise the solution in part C could be implemented without any battery: several options can be combined at will depending on the precise application and trade-offs involving price, the strength of the signal being emitted, the expected lifetime of the dice, the security and even more basically the reliability of the message being carried from the dice to the computer or other electronic system taking the state of the dice as an input, etc.

Remark; when we mention that the dice stop communicating their state to the computer we do not mean that all transmissions between the dice and the computer should stop. To the contrary, in the case of Bluetooth devices we recommend that the channels of communication between the Master and the Slaves be kept open so as to avoid the time delay involved in the recognition of the slave devices by the master in the Piconet. However, in the event that one decides to keep the communication channels between the die and the computer open at all time, it should be noted that a tradeoff occurs, and no more than 7 devices (or dice) can be connected at the same time to the computer as opposed to the solution we had mentioned earlier. This constant communication between die and computer involves also a much higher consumption of energy.

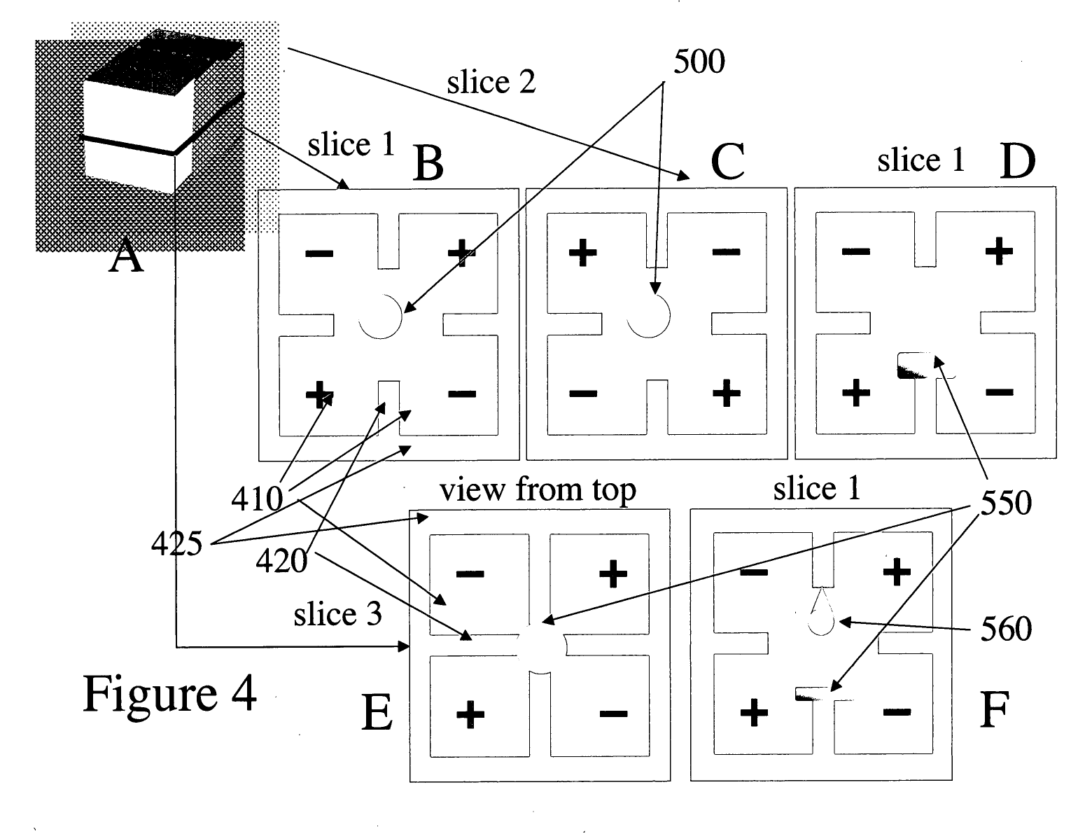

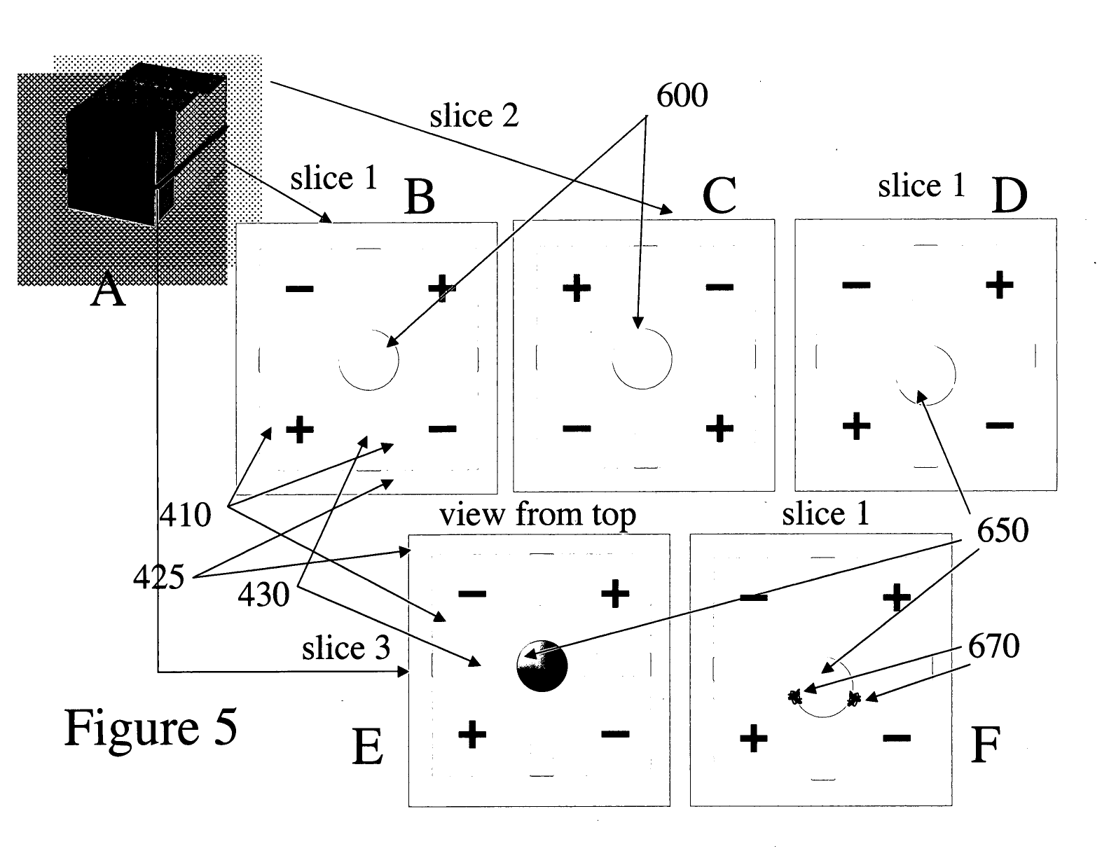

With reference now to FIGS. 4 and 5, it is again gravity which is used to determine the face which is down, but in a more direct way than in FIG. 3 since moving conducting elements will go to the lower part of a cavity in the dice and close specific electric circuits accordingly, thus enacting the emission of the signal transmitting the state of the dice. The difference between the situations in FIGS. 4 and 5 is that the electricity conducting moving part is liquid in FIG. 4, and solid in FIG. 5. We will describe the specificities of these two cases, but first some comments on the commonalities between these two cases and between the figures used to support the discussion:
a) We have in both cases assumed a small central cavity where the detection of the state is done, but one such cavity per face can easily be implemented as a simple modification of the designs presented here.
b) The detection being made as indicated in FIG. 4 or 5 (or with the adapted versions that we have just mentioned in point a)), can be combined with the circuit braking function of motion captors. In this case however, instead of the piezoelectric material described earlier, one or more batteries will generate the other current if the energy gained from the motion is not sufficient for the processing and transmission equipment being used.
c) In both FIG. 4 and FIG. 5, part A is a small copy of the dice carrying the suggested version of the invention, where we have displayed the positions of three planes of cut: slices 1 and 2 are vertical and parallel to each other, they are close to the center of the die where the tiny cavity and tiny circuit breaker/closer will stand (so the distance between these slice is vastly increased in the figures for better visibility). Slice 3 is horizontal and below the center, with the view offered of slice 3, in parts E of both FIG. 4 and FIG. 5 being from above.
d) If good insulators are used, then there is nothing to prevent from combining liquid and solid moving parts. Anyway, whatever solution is chosen the shifts in position should be tiny when compared to the size and weight of the dice. As we have discussed, the recent developments in MEMS and NEMS technologies allow to build all that is needed to follow the teaching of the present invention at microscopic, and in part nanoscopic scales.

The + and − signs figured all over in FIGS. 4 and 5 indicate to which pole of a battery (or other electricity source) the corresponding polarity carrying element 410 is attached. The strips (420 in FIG. 4, 430 in FIG. 5) between the polarity carrying elements and 425 around them are insulations. There are different shades used for 420 in FIGS. 4 and 430 in FIG. 5 to indicate that where a solid conducting moving element is used as in FIG. 5, dry gas or an empty gap can serve as an insulator. Comparing slices 1 and 2 in parts B and C in either FIG. 4 or FIG. 5, we see that there are eight polarity carrying elements, four per polarity, and one per corner of the cube.

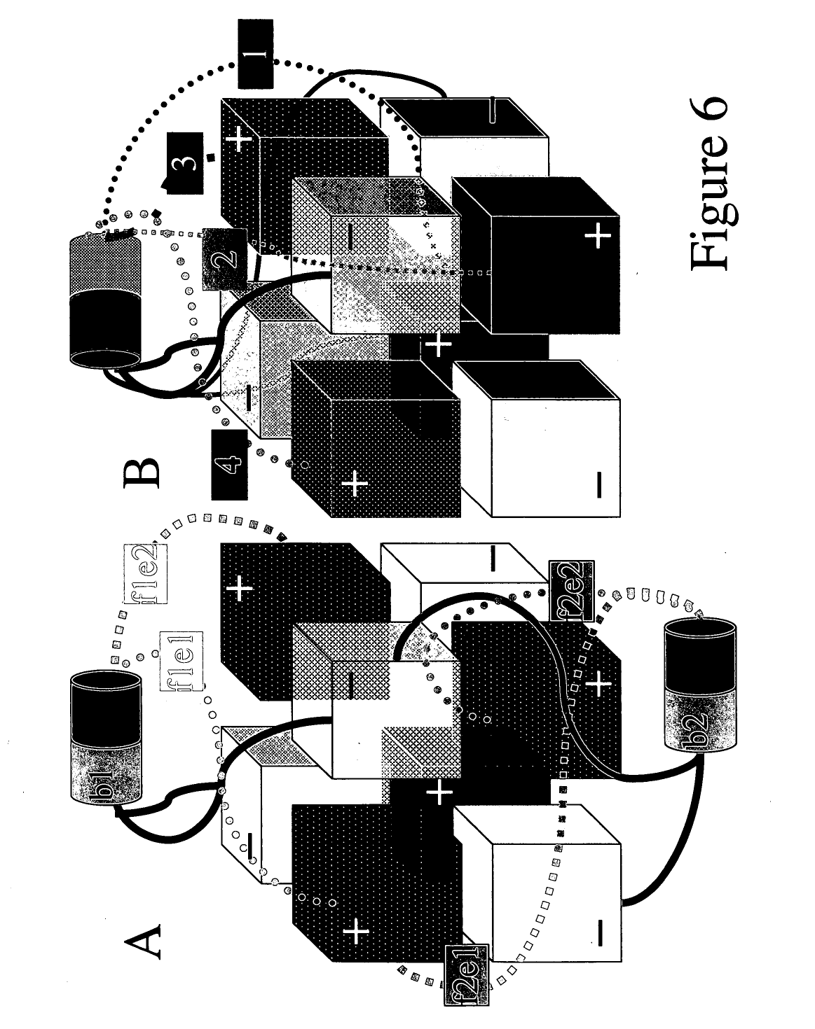

The collection of polarity carrying elements is presented with two kinds of connections to electricity sources in FIG. 6. Thus there are four polarity carrying elements against any of the faces, two per polarity. If each of the faces, say f1, f2, f3, f4, f5, and f6 carries a battery, say b1, b2, b3, b4, b5, and b6, and if each of the batteries bi (with the i of bi set to any of 1,2,3,4,5,6) has its + pole attached to the two + polarity carrying elements against fi (with the i of fi set to be the same index 1,2,3,4,5, or 6), and an emitter specific of face fi (and depending upon the dice) between the + pole of each battery and each of the + polarity carrying element it is attached to (so that there are two emitting elements for face fi, say fie1 and fie2: see part A of FIG. 6)), then contact between the 4 polarity carrying elements attached to face fi will enable emission of the two emitting elements associated to fi and to one element per face adjacent to fi. For instance, two of the six batteries, called b1 and b2 for faces f1 and f2, have been represented in part A of FIG. 6, where (both in pats A and B) solid lines correspond to lines attached to the − polarity elements or sides of the battery (or other electricity generator) while dashed lines are lines attached to the + polarity elements or sides of the battery (or other electricity generator). Thus if the face f1 is at the bottom, the emitting elements fle1 and fle2 will be active and so will be f2e1 on face f2, but f2e2 on face f2 will not be active. In fact, only the top face does not emit, which is one way to recognize it, using six batteries.

Of course, one single battery with its + attached to the four + polarity carrying elements with an emitting element on each line, as represented in part B of FIG. 6 is one other way to proceed. Then one would recognize the face at the bottom by recognizing which two + polarity carrying elements are emitting simultaneously. For instance:
if the lower face from the configuration in part B is down, emitting elements 1 and 2 will be active,
if the front face is down, emitting elements 2 and 4 will be active,
if the left side face is down, emitting elements 1 and 4 will be active,
if the right side face is down, emitting elements 2 and 3 will be active,
if the back side face is down, emitting elements 1 and 3 will be active,
if the top side face is down, emitting elements 3 and 4 will be active.

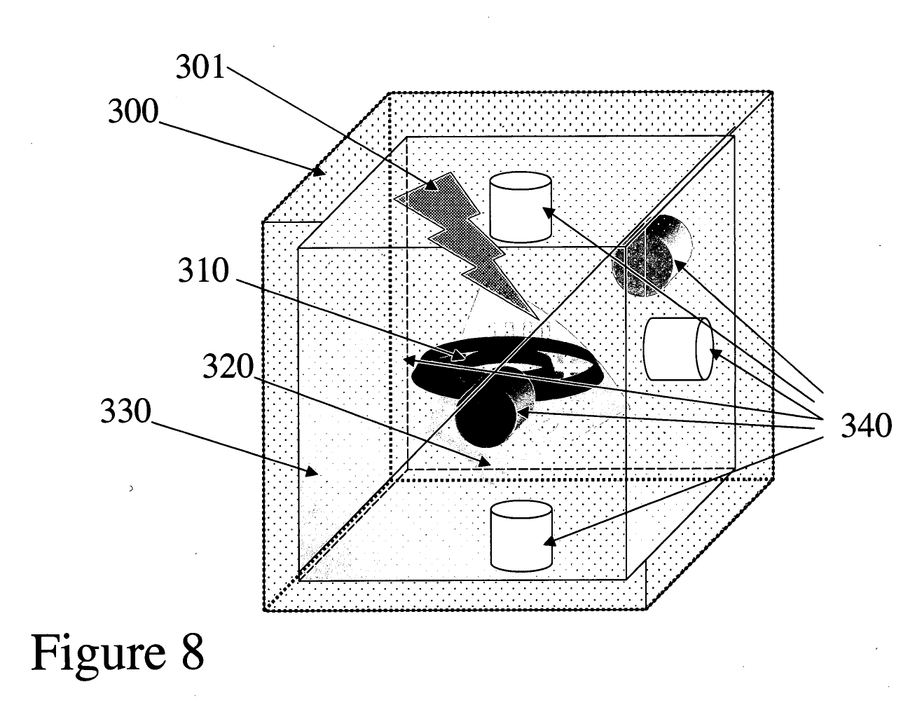

Other ways to connect the battery could be used and the examples in parts A and B of FIG. 6 given should not be understood as being limitative. One can also have a gravity-based detector of the lower position attached to each of the faces, like in the position of the photoelectric cells 340 on FIG. 8, and then only the cell that is in the bottom position emits.

With reference now to FIG. 4 and to FIG. 5, parts B and C are two vertical slices that are used to represent when the conducting element, a liquid at 500 in FIG. 4, a solid round ball at 600 in FIG. 5, has not yet fallen on a side stabilized because the die has not stopped rolling. A single vertical slice in part D and a single horizontal slice in part E are used to show how the conducting element (liquid in FIG. 4, solid in FIG. 5) stabilizes due to the effect of gravity after the die has stopped rolling. This is illustrated at 550 for the liquid conductor in FIG. 4, and at 650 for the liquid conductor in FIG. 5. Thus once the die is stable, the conducting elements create a connection between the two − polarity carrying conducting elements and the two + polarity carrying conducting elements.

With reference to FIG. 4 but now to part F, we see that part of the liquid needs not fall right away if its viscosity is chosen appropriately in accord with the other elements, so that a last substantial drop 560 will fall and more generally, after some intermediate time, only the four bottom conducting elements will participate to open circuits.

With reference to FIG. 5 but now to part F, we see that at 670, there are soft conducting elements making sure that the contact of the ball 650 with the bottom conducting elements is substantial and predictably reproducible.

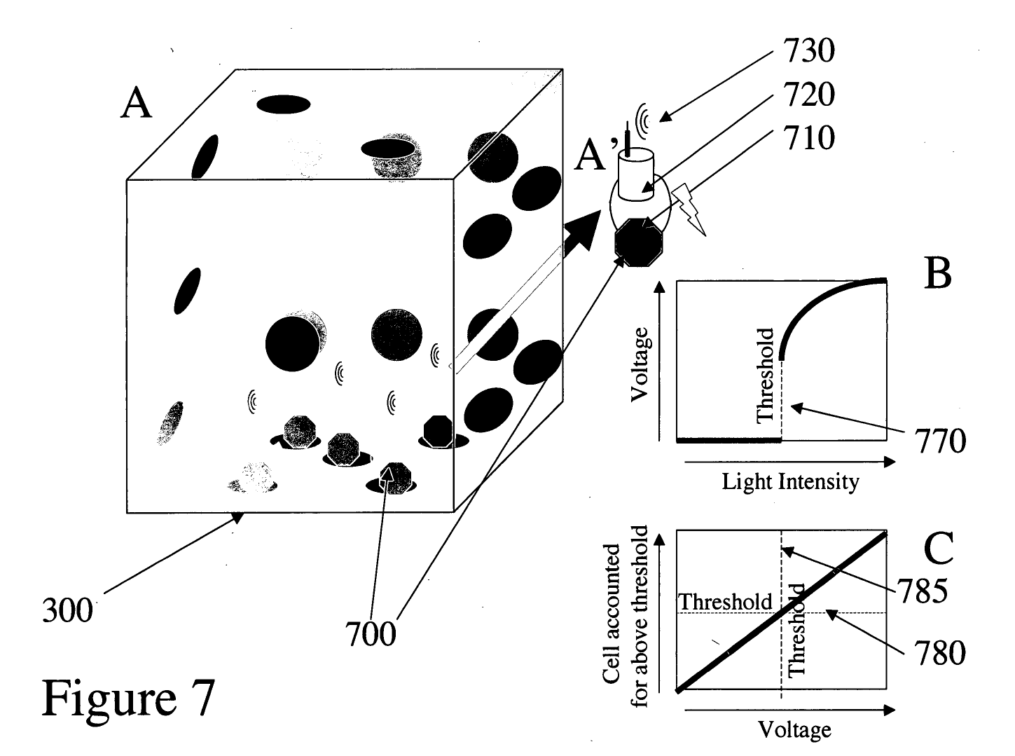

With reference now to FIG. 7, we see photoelectric cells 710 associated to all faces. For instance there might be one cell (e.g., a small photo-sensitive transistor) for each dot on a face for a classical dice with one to six dots per face, and/or there might be cells with different characteristic for all faces. The cell will use transparent spots in the faces to detect light. The cells in the face that is down will receive significantly less light than the cells near the other faces. This significant difference will be the factor that will enable the die to recognize its bottom face, hence its top face. To each cell will be associated a transmitter 720 with an antenna 730, as detailed in part A′. Another possibility would be to have all cells (or all cells near the same face) linked to the same emitter and antenna, where the emitter would total the inputs or recognize the individual contributions of all the cells that receive enough light. Whatever solution is chosen, the following are two options to determine the bottom face:
a) With reference to part B of FIG. 7, each cell will only produce electricity to activate the transmitter and antenna above some threshold 770 in light intensity, or
b) With reference to part C of FIG. 7, the signal sent to the computer will be an increasing function of the light received by the cell. The computer will accept signals only above some threshold 780 signal intensity (corresponding to some threshold 785 in voltage), that comes inside some interval separating without ambiguity the signal strength associated to a down face and another face.

Of course, nothing prevents from using the solutions a) and b) conjointly. The recourse to such photoelectric sensors can easily be used in conjunction with the use of motion captors (or other transducers). This combination would limit the time of emission from when the dice are held in hand to shortly after the dice stop rolling.

Instead of using the electricity producing aspect of the photoelectric effect, one could use the sensor capabilities attached to it: then a signal would fail to arrive from the face that is down to a processor, and the state would be hereby determined.

Instead of photoelectric cells, one could use the Peltier effect, but this may be prone to mistake without the recourse of special equipment.

Note that if Bluetooth technology is to be used in the solutions detailed in the FIGS. 4, 5, 6, and 7, then rather than using several emitters per die we would instead suggest the use of transmitters that would then relay all the information to a unique emitting element located in the die. This would allow the die to be considered as a single device with a single BD Address by the computer involved in the Piconet.

With reference now to FIG. 8, a computing unit at 320 larger than needed for basic use of the Bluetooth or similar protocol, is placed in the die 300 for application where trust in the fairness of the die and in the exactness of the output are important. Such a computing system, running for instance a light version of the Linux operating system that has been adapted to Bluetooth type application at least since the year 2000, would in particular be able to keep in memory all outcomes. It would send signals in case of deviation from fairness, acknowledge unfairness, or give the number of each outcome upon authorized request. The system could be protected using prior art such as the ones used by several computer builders in the protection of secure hardware. Like in said prior art (that includes for instance secure cryptographic coprocessors), we use sensors behind protecting wall 330 that contains a mesh so that the sensors or the mesh break circuits and irreversibly erase the cryptographic keys upon attempts of penetration (a combination of tamper protection and tamper evidence). At 340, one finds said sensors of heat and abnormal fields and other physical characteristics such as electric or magnetic fields and pressure, so that any detected attempt of entering the inside, protected, part of the cube, will result in the cube erasing its cryptographic keys so that an attempt of aggression can be recognized by the die not responding properly to prompts any more. The electricity source 310, be it by batteries or by motion captors (or other transducers) or a combination of both (hence the shading of the lightning sign 301 which has purposely been chosen so as to be between the ones used in parts A and B of FIG. 2) will preferably stay inside the secure barrier 320 if any. The antenna emitting the state of the cube or transmitting data about the cube when prompted by the inside computing or from the outside, may be out of the secure environment delimited by barrier 320 if preferred, since anyway, all transmission will use the digital signature of the die.

Even without getting to higher security concerns, a die can be equipped with a processor with enough computing power to monitor what signal should be sent as soon as the state of the die has been determined:
If motion is detected, the processor would know the time window when to emit this information and keep it in memory for the computer to ask again for it if communication went wrong,
If motion is not detected, then the computer could recognize when information needs to be refreshed from the sequences. Then a signal of different nature would be sent when the die is not at rest, and each new sequence of messages similar to each other would mean a new state.
   The use of a processor to govern the timing of communication (beside the use of that processor in the protocol being utilized) is that the die will be able to tag in a non avoidable way the messages being sent or resent which will help protect against some fraudulent attacks as it is plain to anyone trained in the art of communication security.

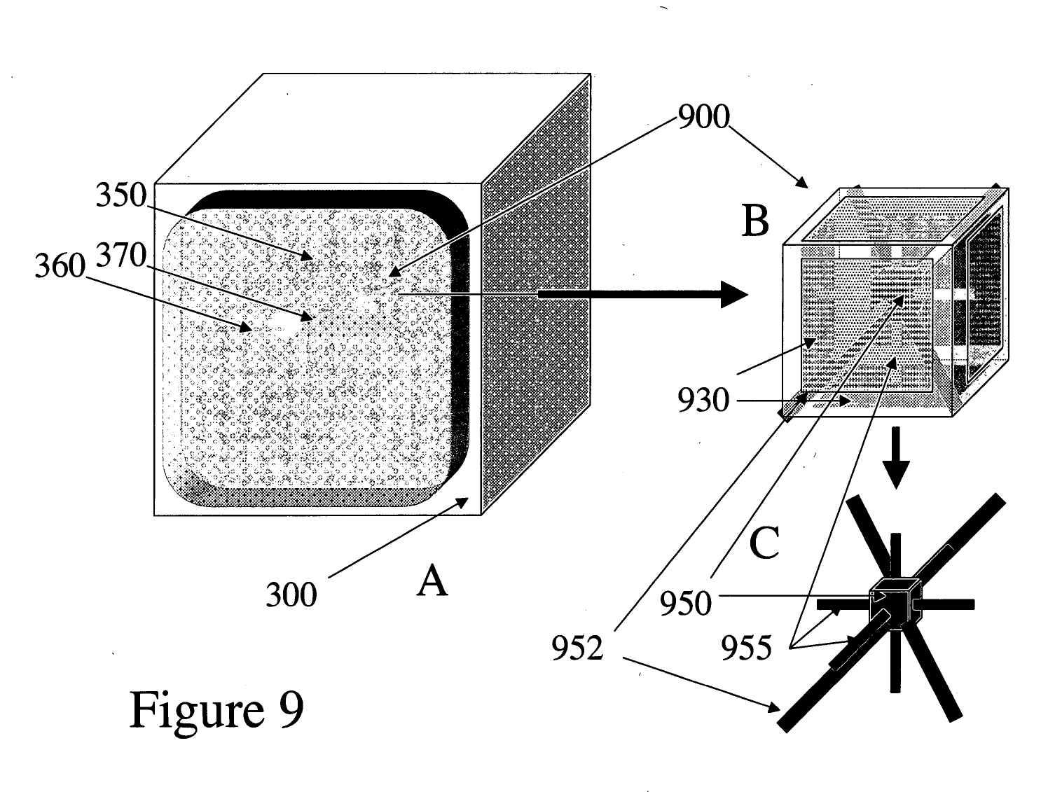

With reference now to FIG. 9, we see a die 300 with for instance the piezoelectric state sensor 350 with circuit 360 and emitter 370. Assuming preferably that there is a secure computing facility inside the die as described previously with reference to FIG. 8, we see at 900 a small region inside the cube and under the control of the embedded computing system (or controlled by some external secure system). Inside small region 900, an engine 950 acts on arms 955 that move little weights 930 (one such weight being available for each face, as one possible choice) to correct the balance of the die if some deviation from fairness is observed. The engine 950 is attached to the rest of the die by static arms 952.

We notice that the transform of the die that we have described to restore the balance can be done by small linear motors (an electric motor that produces a linear force instead of producing a torque (rotation)). Small scale linear motors, using the converse piezoelectric effect (by which an electric current is transformed into pressure, hereby generating strong but tiny motions) are described for instance in U.S. Pat. No. 3,902,084 to W. G. May, Jr., U.S. Pat. No. 3,902,085 to R. A. Bizzigotti, U.S. Pat. No. 4,709,183 to J. Lange and U.S. Pat. No. 5,319,257 to T. J. McIntyre. The whole balancing can thus be made at microscopic scale since there are now linear motors in the MEMS world as described for instance in U.S. Pat. No. 6,380,661 to Henderson, et al. (Linear incremental bi-directional motor), with other form of motors (whose effect would then need to be transformed appropriately) are described for instance in U.S. Pat. No. 6,531,417 to Choi, et al. (Thermally driven micro-pump buried in a silicon substrate and method for fabricating the same), U.S. Pat. No. 6,621,184 to Smoliar, et al. (Substrate based pendulum motor), and U.S. Pat. No. 6,583,374 to Knieser, et al (Microelectromechanical system (MEMS) digital electrical isolator).

While the balancing of the die can aim at being deterministic, it can be statistical instead: after measurement of the statistics of the die, another distribution for random rebalancing could be made so as to have as close as fairness as possible for the sum of the empirical and imposed distributions. Furthermore, as long as the random rebalancing are unknown, they could be performed with lack of balancing important but fair, and occurring after the throw, so as to defeat most if not any type of expert but fraudulent handling of the dice aiming at gaining abnormal control and defeating chance and fairness.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof and that changes may be made therein which still fall within the spirit and scope of the invention. Thus, it is intended that the scope of the present invention herein disclosed should not be limited by the particular disclosed embodiments described above, but should be determined by the appended claims.

1. A die containing at least one embedded system such that when said dice is at rest with one of its face down, said embedded system is in a state whose knowledge allows determination of which face of said die is down.

2. A die as in claim 1 that further, using one or more embedded transmission systems, can transmit at least one of:
said state whose knowledge allows determination of which face of said die is down,
the information of which face is down,
the information of which face is up,
the information of what is the value that can be read on the top face.

3. A die as in claim 2 where the transmission protocol incorporates an identity of said die so that several dice can be used conjointly and the value on the top face is determined by the identity of the bottom face.

4. A die as in claim 2, where the transmission protocol is the Bluetooth protocol.

5. A die as in claim 2 where the transmission protocol is one of the versions of the 802.11 protocols of the Institute of Electronic and Electrical Engineering, such as 802.11b.

6. A die as in claim 1 where the energy necessary for said embedded systems comprises one or more batteries, one or more of which is powered by photoelectric cells or a thermoelectric cell or a motion captor or piezoelectricity.

7. A die as in claim 1 where the energy necessary for said embedded systems comprises no battery but at least one of one or more transducers and one or more capacitors.

8. A die as in claim 2 where the energy necessary for said embedded transmission systems comprises one or more batteries, one or more of which is powered by at least one of a photoelectric cell, a thermoelectric cell, a motion captor, and piezoelectricity.

9. A die as in claim 2 where the energy necessary for said embedded transmission systems comprises no battery but one or more transducers and one or more capacitors.

10. A die as in claim 6 where the die is replaced when the batteries are “dead” or discharged.

11. A die as in claim 2 where the transmission protocol is built ad-hoc.

12. A die as in claim 6 where the batteries can be replaced when they are “dead” or discharged.

13. A die as in claim 1 where detection of the face that is down uses piezoelectric facets that each senses the weight of the die when they are bellow and support the weight of the die.

14. A die as in claim 1 where part or all of the detection of which face of said die is down is based on at least one of gravity, piezoelectricity, the photoelectric effect, and the Peltier effect.

15. A die as in claim 2 where part or all of electricity needed by said die is provided using at least one of piezoelectric material, photoelectric material, and some other transducer.

16. A die as in claim 1 where the detection of the face that is down does not use any moving part.

17. A die as in claim 1 where said die has no moving part.

18. A die as in claim 2 where said die has no moving part.

19. A die as in claim 1 where the detection of the face that is down uses one or more moving portions of said die, that can be solid, or liquid, or a combination of both.

20. A die as in claim 1 where said die is equipped with a memory that keeps account of the outcomes, where said memory either can be reinitialized by authorized parties or cannot be reinitialized.

21. A die as in claim 2 where said die is equipped with a memory that keeps account of the outcomes, where said memory either can be reinitialized by authorized parties or cannot be reinitialized.

22. A die as in claim 1 where said die is equipped with a memory that keeps account of the outcomes, where said memory stores also other data such as time of the throws.

23. A die as in claim 2 where said die is equipped with a memory that keeps account of the outcomes, where said memory stores also other data such as time of the throws.

24. A die as in claim 1 where said die stores information that allows at least one of human agents and the die itself to judge the fairness of said die.

25. A die as in claim 2 where said die stores information that allows at least one of human agents and the die itself to judge the fairness of said die.

26. A die as in claim 1 where said die stores information and have embedded equipment that allows judging and correcting its fairness.

27. A die as in claim 2 where said die stores information and contains embedded equipment that allows judging and correcting its fairness.

28. A die as in claim 2 where all or some of the communication from said die is encrypted.

29. A die as in claim 1 where the embedded systems are securely protected and also permit one to recognize, and allow one to detect fraudulent attempts to break in the die.

30. A die as in claim 2 where the embedded systems are securely protected and also permit one to recognize, and allow one to detect fraudulent attempts to break in the die.

31. A die as in claim 29 where said die emits alerts when fairness is not respected and such that the lack of fairness is acknowledged by the dice upon authorized enquiry.

32. A die as in claim 28 where communication with the dice about the history of the outcome of their throws cannot be performed without the concourse of some authority, such as a private or government game control agency.

33. A die as in claim 1 where said die is cubical as for the game of craps.

34. A die as in claim 2 where said die is cubical as for the game of craps.

35. A die as in claim 1 where said die has rounded corners such as for the game of 421.

36. A die as in claim 2 where said die has rounded corners such as for the game of 421.

37. A die as in claim 1 where said die carries values one to six, one value per face.

38. A die as in claim 2 where said die carries values one to six, one value per face.

39. A die as in claim 1 where said die is a special die such as a die to play poker or Yangtze, a die that carries any set of symbols, either one per face or some repeated some number of times, a die that has a number of faces different from six.

40. A die as in claim 2 where said die is a special die such as a die to play poker or Yangtze, a die that carries any set of symbols, either one per face or some repeated some number of times, a die that has a number of faces different from six.

41. A die as in claim 1 where part or all of the energy needed by the said embedded system is generated by at least one of a motion captor system and a thermal energy captor using the Seebeck effect that respectively transform:
the energy in the motion of the dice communicated by the player when throwing said dice,
and the thermal energy communicated by the player when he or she holds the dice before throwing them into electric energy.

42. A die as in claim 2 where part or all of the energy needed by said embedded detection and transmission systems is generated by at least one of a motion captor system and a thermal energy captor using the Seebeck effect that respectively transform:
the energy in the motion of the dice communicated by the player when throwing said dice,
and the thermal energy communicated by the player when he or she holds the dice before throwing them into electric energy.

43. A die as in claim 42 where the energy produced by said motion captors allows transmission of the state of said die to only persist a short time after each throw.

44. A die as in claim 2 where part of the timing of messages being sent and the composition of said messages is decided by a processor in the die.

45. A die as in claim 2 where said die transmits to an external computing facility that can analyze the transmission to extract the state of the dice.

46. A die as in claim 1 where the state of said die is used in an electronic game such as a video-game using elements of randomness, some or part of said randomness being covered by the use of the die.

47. A die as in claim 2 where the state of said die is used in an electronic game such as a video-game using elements of randomness, some or part of said randomness being covered by the use of the die.

48. A die as in claim 45 where said computing facility enhances or helps displaying the result of the die game.

49. A die as in claim 1 where throws of said die are prompted at some phases of the game, and the state of said die after the throw is recognized and input in the unfolding of the game without any player having any further input to make such as indicating that the throw has been performed and/or that the information sent by said die about its state is complete so that the game can proceed.

50. A die as in claim 2 where throws of said die are prompted at some phases of the game, and the state of said die after the throw is recognized and input in the unfolding of the game without any player having any further input to make such as indicating that the throw has been performed and/or that the information sent by said die about its state is complete so that the game can proceed.

51. A die as in claim 49 where decision on whether the throw of said die had a recognizable output is made by said die or by said dice in synergy with the outside computing facility with some or no exceptions about when some human agent can enter the decision process.

52. A die as in claim 1 where the deduction of the value on the tope face of said die from the knowledge of the face that is down is made by a processor in the die.

53. A die as in claim 2 where the deduction of the value on the top face of said die from the knowledge of the face that is down is made by a processor in the die.

54. A die as in claim 1 where detection of the state of said die is made using photoelectric cells.

55. A die as in claim 1 where detection of the state of said die is made using the photoelectric effect and a special board emitting electromagnetic radiations.

56. A die as in claim 1 where detection of the state of said die is made using the Peltier effect and a special board emitting heat.

57. A die as in claim 2 where detection of the state of said die is made using photoelectric cells.

58. A die as in claim 2 where detection of the state of said die is made using the photoelectric effect and a special board emitting electromagnetic radiations.

59. A die as in claim 2 where detection of the state of said die is made using the Peltier effect and a special board emitting heat.

60. A die as in claim 1 where part or all of the teaching can be realized as MEMS or NEMS size modifications of an usual die.

61. A die as in claim 2 where part or all of the teaching can be realized as MEMS or NEMS size modifications of an usual die.

62. A method for a die to recognize which face is up.

63. A method for a die to recognize which face is up and for transmitting this information to a computer.

64. A method for a die to recognize which face is up and for transmitting this information to a computer for display.

65. A method for a die to recognize which face is up and for transmitting this information to a computer for use in an electronic game.

66. A method for a die to recognize which face is up and keep the history of such die values.

66. A method for a die to recognize which face is up and keep the history of such die values in a secure way.

67. A method for a die to recognize which face is up, to keep the history of such die values and to check its own fairness.

68. A method for a die to recognize which face is up, to keep the history of such die values, to check its own fairness, and to correct it.

69. A method for a die to recognize which face is up, to keep the history of such die values, to check its own fairness, and correct it in a deterministic way.

70. A method for a die to recognize which face is up, to keep the history of such die values, to check its own fairness, and correct it in a random way.
